(19) United States
(12) Patent Application Publication
(10) Pub. No.: US 2009/0105365 A1
(43) Pub. Date: Apr. 23, 2009

(54) Elastomer Composition

(75) Inventors: Jun Konishi, Kanagawa (JP); Atsushi Sugawara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 11/920,084

(22) PCT Filed: May 10, 2006
(86) PCT No.: PCT/JP2006/309763

§ 371 Date: Nov. 8, 2007

Related U.S. Application Data
(60) Provisional application No. 60/687,322, filed on Jun. 6, 2005.

(30) Foreign Application Priority Data
May 11, 2005 (JP) 2005-138278

(51) Int. Cl. C08K 3/26; A61J 1/00

(52) U.S. Cl. 523/100; 524/424; 524/109

(57) ABSTRACT

A chlorinated polyolefin composition, including 100 mass parts of a chlorinated polyolefin, 1 to 15 mass parts of an epoxy derivative, and 0.05 to 3 mass parts of a stabilizer. The chlorinated polyolefin is obtained by chlorinating a polyolefin being selected from ethylene homopolymer or ethylene-alpha-olefin copolymer, and has a density of 0.90 or more; and the chlorinated polyolefin has a chlorine content of 25 to 45% by mass, a melt flow rate of 0.1 to 300 g/10 minutes, and a heat of crystal fusion as determined by DSC of 20 to 60 J/g. The epoxy derivative is selected from epoxidized unsaturated oil, and epoxidized unsaturated fatty acid ester, epichlorhydrin derivative and epoxycyclohexane derivative, and the stabilizer is selected from a hydrotalcite minerals.

### CROSS REFERENCE TO RELATED APPLICATION

This application is an application filed under 35 U.S.C. § 111(a) claiming benefit pursuant to 35 U.S.C. § 119(e) of the filing date of Provisional Application 60/687,322, filed on Jun. 6, 2005, pursuant to 35 U.S.C. § 111(b).

### TECHNICAL FIELD

The present invention relates to a chlorinated polyolefin and a composition which has the chlorinated polyolefin. More particularly, the present invention relates to a chlorinated polyolefin, and a composition which has the chlorinated polyolefin, that is suitable as a material of a thermoplastic elastomer for constituting tubes, sheets, films and so forth for medical, food and other industrial applications having superior transparency, mechanical strength, γ0 ray-resistant sterilizability and solvent adhesion property as well as superior safety substantially without containing a plasticizer.

### BACKGROUND ART

Chlorinated polyolefins are chlorination products obtained by chlorinating polyolefins such as polyethylene. Chlorinated polyolefins used for resin modification or as crosslinked rubber and thermoplastic elastomers are typically used as modifiers of ABS and polyvinyl chloride resins and in wire coverings, automotive and industrial rubber parts, rubber magnets and so forth.

In addition, inexpensive, soft polyvinyl chloride is widely used in tubes, sheets and films for medical, food and other industrial applications, and more specifically, in transfusion sets, blood circuits for artificial renal dialysis, wrapping film and various types of hoses, due to its superior transparency, mechanical strength and solvent adhesion property.

However, although soft polyvinyl chloride resin is obtained by heating and kneading a composition composed of polyvinyl chloride powder, plasticizer and other components, and the inexpensive, general-purpose plasticizer, di(2-ethylhexyl)phthalate (DOP), is used for the plasticizer, there has recently been a growing demand for materials not containing phthalic acid esters in consideration of problems associated with so-called environmental hormones (endocrine disruptors).

In addition, many of the medical devices using tubes or films made of soft polyvinyl chloride are sterilized with ethylene oxide. This is because γ-ray sterilization causes deterioration of the polyvinyl chloride itself.

However, since sterilization with ethylene oxide is considered to have a problem in terms of its effect on the environment when residual gas following sterilization, namely gas remaining within pouch or bag materials, is released during opening, there is a growing tendency to use γ-ray sterilization.

As one solution to this problem, the use of an alternative plasticizer has been proposed. More specifically, this involves a change from phthalic acid ester to a trimellitic acid-based plasticizer such as trioctyl trimellitate (TOTM) or tri-(2-ethylhexyl)trimellitate. In this method, although the amount of plasticizer eluted is suppressed, there is no difference with respect to still containing a plasticizer, and the problem of being resistant to γ-ray sterilization remains unsolved.

In addition, as another solution, a thermoplastic elastomer composition has been proposed that does not contain a plasticizer. Typical examples include polybutadiene and/or a composition of polybutadiene and another polymer (JP-A (Japanese Unexamined Patent Publication) No. 2002-11092, Patent Document 1; and JP-A No. 2004-187817, Patent Document 2). However, not only is polybutadiene unsatisfactory with respect to γ-ray-resistant sterilizability, since it also prevents solvent adhesion property, there are problems with reliability when joining tubes with other parts.

As has been described above, conventional alternative materials to soft polyvinyl chloride containing DOP have both advantages and disadvantages, and do not yet warrant their taking the place of soft polyvinyl chloride.

On the other hand, conventional chlorinated polyolefins and compositions thereof lack satisfactory transparency and mechanical strength, and said materials have yet to be found that satisfy these requirements while also realizing solvent adhesion property.

Patent Document 1: JP-A No. 2002-11092

Patent Document 2: JP-A No. 2004-187817

### DISCLOSURE OF THE INVENTION

An object of the present invention is to provide an elastomer composition which contains substantially no plasticizer such as DOP or TOTM, allows γ-ray sterilization and has a solvent adhesion property, and demonstrates superior performance in terms of the finished product when formed into a tube and so forth.

A more specific object of the present invention is to provide an elastomer composition which is capable of providing a performance in terms of transparency, mechanical strength, permanent elongation and anti-crazing.

As a result of earnest study, the present inventors have found that the above-mentioned problems encountered in the prior art can be solved by combining specific amounts of a chlorinated polyolefin having specific properties, an epoxy derivative and a stabilizer selected from a hydrotalcite minerals, to thereby accomplish the present invention.

The present invention includes, for example, the following embodiments of [1] to [9].

[1] A chlorinated polyolefin composition, comprising 100 mass parts of a chlorinated polyolefin, 1 to 15 mass parts of an epoxy derivative, and 0.05 to 3 mass parts of a stabilizer;

[wherein the chlorinated polyolefin is obtained by chlorinating a polyolefin being selected from ethylene homopolymer or ethylene-x-olefin copolymer, and has a density of 0.90 or more; and the chlorinated polyolefin has a chlorine content of 25 to 45% by mass, a melt flow rate of 0.1 to 300 g/10 minutes, and a heat of crystal fusion as determined by DSC of 20 to 60 J/g;

the epoxy derivative is selected from epoxidized unsaturated oil, and epoxidized unsaturated fatty acid ester, epichlorhydrin derivative and epoxycyclohexane derivative, and

the stabilizer is selected from a hydrotalcite minerals.

[2] A chlorinated polyolefin composition according to [1], which further comprises 0.05 to 3 mass parts of a lubricant selected from fatty acid derivatives.

[3] A chlorinated polyolefin composition according to [1] or [2], which has a rebound resilience of 60% or less and a JIS-A hardness of 50 to 90.

[4] A chlorinated polyolefin composition according to any one of [1] to [3], which has an internal haze of 3% or less.

[5] A chlorinated polyolefin composition according to any one of [1] to [4], wherein the epoxy derivative is an epoxidized soybean oil.

[6] A chlorinated polyolefin composition according to any one of [1] to [5], wherein the stabilizer selected from hydrotalcite minerals is hydrotalcite.

[7] An article comprising a composition according to any one of [1] to [6] or a crosslinked product thereof, which has a form or shape of tube, sheet, film or cast molded product capable of constituting a medical device, health care supply or pharmaceutical packaging.

[8] An article comprising a composition according to any one of [1] to [6] or a crosslinked product thereof, which has a form or shape of tube, sheet or film capable of constituting a food container or packaging material; hose or sheet for industrial use; or molded product for food packaging or industrial use.

[9] An article according to [7] or [8], which has been sterilized by β-ray radiation.

### BEST MODE FOR CARRYING OUT THE INVENTION

### Chlorinated Polyolefin Composition

The chlorinated polyolefin composition according to the present invention comprises 100 mass parts of a chlorinated polyolefin, 1 to 15 mass parts of an epoxy derivative, and 0.05 to 3 mass parts of a stabilizer selected from a hydrotalcite minerals.

The chlorinated polyolefin used in the present invention is obtained by chlorinating the raw material polyolefin by an ordinary method such as the aqueous suspension method or the vapor phase method and so forth, and there are no limitations on the chlorination method. In addition, examples of the conditions of the chlorination reaction include a method involving continuous chlorination at a temperature equal to or lower than the crystal melting peak temperature according to the DSC method for raw material polyolefins, and a method comprising a first step in which a polyolefin is chlorinated at a temperature equal to or higher than the crystal melting initiation temperature according to the DSC method for raw material olefins and at least 10° C. lower than the crystal melting peak temperature, a second step in which the supply of chlorine is interrupted followed by heat treatment by heating to a temperature that exceeds a temperature 5° C. lower than the crystal melting peak temperature, and a third step in which chlorination is repeated.

### (Physical Properties of Chlorinated Polyolefin)

In addition, the chlorinated polyolefin may preferably has a physical property such that it has a chlorine content of 25 to 45% by mass, a melt flow rate of 0.1 to 300 g/10 minutes, and more preferably 1 to 300 g/10 minutes, and a heat of crystal fusion as determined by the DSC method of 20 to 60 J/g. If the chlorine content is less than 25% by mass, since strength decreases during solvent adhesion and rebound resilience is high, there is a tendency to lack pliancy. On the other hand, if the chlorine content is more than 45% by mass, there is a tendency for hardness to increase resulting in a lack of flexibility. If the melt flow rate is less than 0.1 g/10 minutes, molding becomes difficult to due inferior fluidity, the surface becomes rough during extrusion molding, and other problems occur easily such as being unable to be molded during injection molding. On the other hand, if the melt flow rate exceeds 300 g/10 minutes, there is susceptibility to the occurrence of problems such as decreased tensile shear strength and insufficient durability due to the molecular weight of the chlorinated polyolefin being excessively low. If the heat of crystal fusion is less than 20 J/g, the tensile modulus and strength are lacking due to a shortage of the constraining phase, and there is susceptibility to the occurrence of problems such as readily elongating to an irreversible degree. On the other hand, if the heat of crystal fusion exceeds 60 J/g, hardness tends to increase resulting in a lack of flexibility. More preferably, the proportion of the absence of chlorine atoms substituted at a total of hydrogen atoms bonded to five carbon atoms (including the carbon atom intended to be measured by carbon-13 NMR, and two adjacent carbon atoms on both sides thereof) may be 10 to 50 mol %.

In addition, it is also possible to use in combination a plurality of chlorinated polyolefins obtained by individual chlorination. An example of a method of combining the use of a plurality of chlorinated polyolefins comprises mixing a plurality of chlorinated polyolefins at a predetermined ratio when kneading the chlorinated polyolefins, epoxy derivative and stabilizer, etc.

### (Raw Material Polyolefin)

Examples of raw material polyolefins that can be used in the present invention include crystalline polymers having density of 0.90 or more such as homopolymers of α-olefins such as ethylene, propylene, butene-1, pentene-1, hexene-1 and octene-1,4-methylpentene-1, and copolymers of ethylene and α-olefins or two or more types of copolymers of these α-olefins. Here, copolymers include both random and block copolymers. In general, there is a correlation between density and crystallinity, and accordingly, it is preferred to use a raw material polyolefin having a density of 0.90 or more so as to have a certain degree of crystallinity.

In addition, these polyolefins may be powders obtained by a production process, or the crushed products of pellets or beads and so forth that were initially melted and kneaded, and two or more types can be mixed during melting and kneading. Melting and kneading are carried out using ordinary methods, and although they are typically carried out at a temperature equal or higher than the melting point of the polyolefin, there are no particular limitations on the method or temperature provided the objective of ensuring uniformity within the molded product is achieved. Although melting and kneading are typically carried out using an extruder or similar device, there are no particular limitations on the method provided the objective of making a molded product uniform is achieved by going through a process in which one or a plurality of raw materials selected from a powder obtained from a polyolefin production process or solid product that has already been molded by melting and kneading is temporarily melted, cooled after applying physical shearing, and then solidified. In addition, although crushing using a shear-type crusher is better suited to crushing polyolefins than an impact-type crusher, there are no particular limitations on the crushing method. The mean particle diameter of a powder or crushed product obtained from a production process may preferably be 500 μm or less. The mean particle diameter is expressed as the particle diameter of 50% of the particles based on weight. If the mean particle diameter is larger than 500 μm, it becomes difficult to uniformly chlorinate the center of the polyolefin powder, and as a result, in addition to transparency being unsatisfactory, resistance to heat discoloration becomes inferior and there are cases of discoloration to a slight yellow color during kneading.

### (Epoxy Derivative)

An epoxy derivative to be used in the present invention refers to that which has an epoxy group in a molecule thereof and is typically used as a stabilizer of polyvinyl chloride resin and so forth, and examples include epoxidized unsaturated fats and oils, epoxidized unsaturated fatty acid esters, epichlorhydrin derivatives and epoxycyclohexane derivatives. Specific examples include epoxidized soybean oil, epoxidized linseed oil, epoxidized linseed oil butyl fatty acid and epoxidized castor oil, and preferably epoxidized soybean oil.

The amount of epoxy derivative added to the composition according to the present invention is 1 to 15 mass parts. If the amount added is less than 1 part by mass, resistance to thermal deterioration during molding becomes unsatisfactory, while if the amount added exceeds 15 mass parts, there is no change in resistance to thermal deterioration and there is increased susceptibility to the occurrence of problems such as stickiness of the surface after molding.

In addition, a plurality of these epoxy derivatives can also be used as a mixture. Moreover, a composite stabilizer can also be used by adding other stabilizers such as metal salts of fatty acids or metal oxides to these epoxy derivatives. In this case, the content of epoxy derivative in the composite stabilizer may preferably be 50% by mass or more.

### (Stabilizer)

A stabilizer selected from a group of hydrotalcite minerals used in the present invention refers to a compound represented by the general formula MgₐMe_{b}(OH)_{c}CO₃.nH₂O (wherein, Me represents Al, Cr or Fe, a represents an integer of 1 to 10, b represents an integer of 1 to 5, c represents an integer of 1 to 20, and n represents an integer of 0 to 8). In the above formula, a compound in which n is 0 is equivalent to that resulting from baking said compound at a temperature of 250 to 350° C. to remove the crystalline water. The mean particle diameter of said compound is 0.1 to 150 μm, and compounds having a mean particle diameter of 0.5 to 100 μm are preferable. Examples of the group of hydrotalcite minerals include Mg_{4.5}Al₂(CO₃)OH₁₃.3.5H₂O and Mg₆Al₂(CO₃)(OH)₁₆.4H₂O.

Although hydrotalcite exists in nature, synthetic hydrotalcite is commonly used. In the present invention as well, a synthetic hydrotalcite having the structure represented by formula 1 is preferable.

MgₐAl_{b}(OH)_{c}CO₃.nH₂O (Formula 1)

In this formula, a represents an integer of 1 to 10, b represents an integer of 1 to 5, c represents an integer of 10 to 20, and n represents an integer of 0 to 8.

The amount of stabilizer selected from a group of hydrotalcite minerals added to the composition according to the present invention is 0.05 to 3 mass parts. If the amount added is less than 0.5 mass parts, resistance to thermal deterioration during molding becomes unsatisfactory, while if the amount added exceeds 3 mass parts, transparency and anti-crazing by drawing out are inferior.

In addition, a plurality of stabilizers can be combined and used as a mixture for the stabilizer selected from a group of hydrotalcite minerals used in the present invention provided they contain a compound represented by formula 1.

### (Lubricant)

Further, in addition to a chlorinated polyolefin, epoxy derivative and stabilizer selected from a group of hydrotalcite minerals, a lubricant selected from fatty acid derivatives may preferably be added. Examples of lubricants selected from fatty acid derivatives used in the present invention may include fatty acids, fatty acid amides and fatty acid esters. Specific examples include stearic acid, stearamide, oleyl amide, erucyl amide, behenamide and other monoamides of higher fatty acids, ethylene bisstearamide and other bisamides of higher fatty acids, compound amides of different types of higher fatty acids, fatty acid esters and/or phosphate esters such as n-butyl stearate, and glycerin fatty acid esters such as stearic acid monoglyceride, oleic acid monoglyceride and behenic acid monoglyceride.

In the case of adding a lubricant to the composition according to the present invention, the amount added may preferably be 0.05 to 3 mass parts.

In the present invention, a plurality of types of these lubricants can also be combined and used as a mixture.

### (Rebound Resilience)

The rebound resilience of the chlorinated polyolefin composition according to the present invention may preferably be 60% or less, more preferably 50% or less, and even more preferably 40% or less. The higher the rebound resilience, the easier it is to convey impacts or vibrations and so forth occurring during a procedure to the body through, for example, a catheter needle, in the case of using in an application such as a medical tube.

### (JIS-A Hardness)

In addition, the JIS-A hardness of the chlorinated polyolefin composition according to the present invention may preferably be 50 to 90, and more preferably 60 to 80. If the hardness exceeds 90, it is too hard for use as a tube, for example, and the required flexibility and workability easily become unsatisfactory. In addition, if the hardness is less than 50, the composition is excessively soft, making it susceptible to the occurrence of problems such as blockage and bending when used, for example, as a tube.

### (Internal Haze)

The amount of internal haze of the chlorinated polyolefin composition according to the present invention is 3% or less and preferably 2% or less. If the amount of internal haze exceeds 3%, transparency easily becomes unsatisfactory, and in the case of transfusion tube, for example, it becomes difficult to visually confirm the presence of a colorless, transparent liquid flowing through the tube.

### (Usage or Application)

The chlorinated polyolefin composition according to the present invention or crosslinked product thereof can be used as a component that composes a medical device, health care supply, pharmaceutical packaging, food container or packaging or industrial hose or film, e.g., by molding the composition into a tube, sheet, film or cast molded product. Examples of these applications include various types of tubes such a transfusion set tube, blood circuit tube or feeding tube, catheters, films such as a urine collection bag or transfusion bag, liquid transfer tubes for food or food industrial applications, and packaging films.

Although the following provides a detailed explanation of the present invention using examples and comparative examples, the present invention is not limited to these examples alone.

### EXAMPLE 1

Pellets of a high-pressure ethylene/α-olefin copolymer having a melt flow rate (MFR) of 17 g/10 minutes at a load of 2.16 kg and temperature of 190° C. and a density of 0.912 (Japan Polyethylene Corporation, Kernel) were crushed to a mean particle diameter of 350 μm with a grinding crusher to obtain a raw material polyolefin, followed by chlorinating to a chlorine content of 30% by mass in an aqueous suspension at 75° C. using a 100 L glass-lined autoclave.

The resulting chlorinated polyolefin was in the form of a white powder, the MFR was 120 g/10 minutes at a load of 21.6 kg and temperature of 180° C., and the heat of crystal fusion as determined by the DSC method was 30 J/g.

5 mass parts of epoxidized soybean oil (Asahi Denka Co., Ltd., 0-130P, to apply similarly hereinafter), 0.5 mass parts of hydrotalcite (Kyowa Chemical Industry Co., Ltd., DHT-4A, to apply similarly hereinafter) and 0.2 mass parts of lubricant in the form of stearic acid monoglyceride (Riken Vitamin Co., Ltd., Rikemal, to apply similarly hereinafter) were added to 100 mass parts of this chlorinated polyolefin followed by kneading with an 8-inch roller at 130° C., molding with a hot press at 170° C. and using for evaluation.

### EXAMPLE 2

High-density polyethylene powder having an MFR of 7.5 g/10 minutes at a load of 2.16 kg and temperature of 190° C. and density of 0.956 (Japan Polyethylene Corporation, Novatec) was crushed to a mean particle diameter of 250 μm with a grinding crusher to obtain a raw material polyolefin followed by chlorinating to a chlorine content of 25% by mass in an aqueous suspension at 115° C. using a 100 L glass-lined autoclave. After then discontinuing the supplying of chlorine gas, the temperature was raised to 134° C. and then lowered to 107° C. followed by resuming the supply of chlorine gas and chlorinating to a total chlorine content of 35% by mass at 107° C.

The resulting chlorinated polyolefin was in the form of a white powder, the MFR was 50 g/10 minutes at a load of 21.6 kg and temperature of 180° C., and the heat of crystal fusion as determined by the DSC method was 39 J/g. 10 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### EXAMPLE 3

Example 3 was carried out in the same manner as Example 1 using the chlorinated polyolefin of Example 1 with the exception of changing the amount of epoxidized soybean oil to 10 mass parts.

### EXAMPLE 4

Pellets of a vapor-phase metallocene-based polyethylene having an MFR of 15 g/10 minutes at a load of 2.16 kg and temperature of 190° C. and a density of 0.910 (Japan Polyethylene Corporation, Harmorex) were crushed to a mean particle diameter of 350 μm with a grinding crusher to obtain a raw material polyolefin, followed by chlorinating to a chlorine content of 30% by mass in an aqueous suspension at 83° C. using a 100 L glass-lined autoclave.

The resulting chlorinated polyolefin was in the form of a white powder, the MFR was 115 g/10 minutes at a load of 21.6 kg and temperature of 180° C., and the heat of crystal fusion as determined by the DSC method was 32 J/g.

5 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### EXAMPLE 5

The same raw material polyolefin as that used in Example 1 was chlorinated to a chlorine content of 35% by mass in an aqueous suspension at 73° C. using a 100 L glass-lined autoclave.

The resulting chlorinated polyolefin was in the form of a white powder, the MFR was 95 g/10 minutes at a load of 21.6 kg and temperature of 180° C., and the heat of crystal fusion as determined by the DSC method was 23 J/g.

10 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### EXAMPLE 6

The same raw material polyolefin as that used in Example 1 was chlorinated to a chlorine content of 30% by mass in an aqueous suspension at 82° C. using a 100 L glass-lined autoclave.

The resulting chlorinated polyolefin was in the form of a white powder, the MFR was 142 g/10 minutes at a load of 21.6 kg and temperature of 180° C., and the heat of crystal fusion as determined by the DSC method was 21 J/g.

5 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### EXAMPLE 7

High-density polyethylene powder having an MFR of 20 g/10 minutes at a load of 2.16 kg and temperature of 190° C. and density of 0.960 (Japan Polyethylene Corporation, Novatec) was crushed to a mean particle diameter of 250 μm with a grinding crusher to obtain a raw material polyolefin followed by chlorinating to a chlorine content of 25% by mass in an aqueous suspension at 110° C. using a 100 L glass-lined autoclave. After then discontinuing the supplying of chlorine gas, the temperature was raised to 135° C. and then lowered to 100° C. followed by resuming the supply of chlorine gas and chlorinating to a total chlorine content of 40% by mass at 100° C.

The resulting chlorinated polyolefin was in the form of a white powder, the MFR was 32 g/10 minutes at a load of 21.6 kg and temperature of 180° C., and the heat of crystal fusion as determined by the DSC method was 40 J/g. 10 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### EXAMPLE 8

Pellets of a high-pressure ethylene/α-olefin copolymer having a melt flow rate (MFR) of 2.5 g/10 minutes at a load of 2.16 kg and temperature of 190° C. and a density of 0.921 (Japan Polyethylene Corporation, Kernel) were crushed to a mean particle diameter of 350 μm with a grinding crusher to obtain a raw material polyolefin, followed by chlorinating to a chlorine content of 30% by mass in an aqueous suspension at 77° C. using a 100 L glass-lined autoclave.

The resulting chlorinated polyolefin was in the form of a white powder, the MFR was 19 g/10 minutes at a load of 21.6 kg and temperature of 180° C., and the heat of crystal fusion as determined by the DSC method was 33 J/g.

30 mass parts of this chlorinated polyolefin were mixed with 70 mass parts of the chlorinated polyolefin obtained in Example 1, after which 5 mass parts of epoxidized soybean oil (Asahi Denka Co., Ltd., O-130P), 0.5 mass parts of hydrotalcite (Kyowa Chemical Industry Co., Ltd., DHT-4A) and 0.2 mass parts of lubricant in the form of stearic acid monoglyceride (Riken Vitamin Co., Ltd., Rikemal) were added to 100 mass parts of this chlorinated polyolefin mixture followed by kneading with an 8-inch roller at 130° C., molding with a hot press at 170° C. and using for evaluation.

### EXAMPLE 9

Pellets of a high-pressure ethylene/α-olefin copolymer having a melt flow rate (MFR) of 11 g/10 minutes at a load of 2.16 kg and temperature of 190° C. and a density of 0.919 (Japan Polyethylene Corporation, Kernel) were crushed to a mean particle diameter of 350 μm with a grinding crusher to obtain a raw material polyolefin, followed by chlorinating to a chlorine content of 30% by mass in an aqueous suspension at 75° C. using a 100 L glass-lined autoclave.

The resulting chlorinated polyolefin was in the form of a white powder, the MFR was 43 g/10 minutes at a load of 21.6 kg and temperature of 180° C., and the heat of crystal fusion as determined by the DSC method was 31 J/g.

5 mass parts of epoxidized soybean oil (Asahi Denka Co., Ltd., 0-130P), 0.5 mass parts of hydrotalcite (Kyowa Chemical Industry Co., Ltd., DHT-4A) and 0.2 mass parts of lubricant in the form of stearic acid monoglyceride (Riken Vitamin Co., Ltd., Rikemal) were added to 100 mass parts of the resulting chlorinated polyolefin followed by kneading with an 8-inch roller at 130° C., molding with a hot press at 170° C. and using for evaluation.

### COMPARATIVE EXAMPLE 1

The same raw material polyolefin as Example 1 was chlorinated under the same conditions as Example 1 with the exception of chlorinating to a chlorine content of 20% by mass.

The resulting chlorinated polyolefin was in the form of a white powder, the MFR was 180 g/10 minutes at a load of 21.6 kg and temperature of 180° C., and the heat of crystal fusion as determined by the DSC method was 45 J/g.

5 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### COMPARATIVE EXAMPLE 2

The same raw material polyolefin as Example 2 was chlorinated to a chlorine content of 50% by mass in an aqueous suspension at 115° C. using a 100 L glass-lined autoclave.

The resulting chlorinated polyolefin was in the form of a milky white powder, the MFR was 15 g/10 minutes at a load of 21.6 kg and temperature of 180° C., and the heat of crystal fusion as determined by the DSC method was 20 J/g.

10 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### COMPARATIVE EXAMPLE 3

The same raw material polyolefin as Example 2 was chlorinated to a chlorine content of 15% by mass in an aqueous suspension at 115° C. using a 100 L glass-lined autoclave. After then discontinuing the supplying of chlorine gas, the temperature was raised to 135° C. and then lowered to 120° C. followed by resuming the supply of chlorine gas and chlorinating to a total chlorine content of 30% by mass at 120° C.

The resulting chlorinated polyolefin was in the form of a white powder, the MFR was 94 g/10 minutes at a load of 21.6 kg and temperature of 180° C., and the heat of crystal fusion as determined by the DSC method was 0.2 J/g.

5 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### COMPARATIVE EXAMPLE 4

The same raw material polyolefin as Example 2 was chlorinated to a chlorine content of 15% by mass in an aqueous suspension at 115° C. using a 100 L glass-lined autoclave. After then discontinuing the supplying of chlorine gas, the temperature was raised to 135° C. and then lowered to 105° C. followed by resuming the supply of chlorine gas and chlorinating to a total chlorine content of 40% by mass at 105° C.

The resulting chlorinated polyolefin was in the form of a white powder, the MFR was 13 g/10 minutes at a load of 21.6 kg and temperature of 180° C., and the heat of crystal fusion as determined by the DSC method was 31 J/g. This chlorinated polyolefin was kneaded and pressed in the same manner as Example 1 and used for evaluation.

### COMPARATIVE EXAMPLE 5

0.5 mass parts of epoxidized soybean oil, 0.01 mass parts of hydrotalcite and 0.01 mass parts of lubricant in the form of stearic acid monoglyceride were added to 100 mass parts of the same chlorinated polyolefin as Example 7 followed by kneading and pressing in the same manner as Example 1 and using for evaluation.

### COMPARATIVE EXAMPLE 6

An ethylene/propylene copolymer powder having an MFR of 190° C. of 8 g/10 minutes at a load of 2.16 kg and temperature and density of 0.890 (Japan Polyolefin) was crushed to a mean particle diameter of 350 μm with a grinding crusher to obtain a raw material polyolefin followed by chlorinating to a chlorine content of 30% by mass in an aqueous suspension at 85° C. using a 100 L glass-lined autoclave.

The resulting chlorinated polyolefin was in the form of a white powder, the MFR was 80 g/10 minutes at a load of 21.6 kg and temperature of 180° C., and the heat of crystal fusion as determined by the DSC method was 19 J/g.

5 mass parts of epoxidized soybean oil, 0.5 mass parts of hydrotalcite and 0.2 mass parts of lubricant in the form of stearic acid monoglyceride were added to 100 mass parts of this chlorinated polyolefin followed by kneading and pressing in the same manner as Example 1 and using for evaluation.

### COMPARATIVE EXAMPLE 7

80 mass parts of a plasticizer (New Japan Chemical Co., Ltd., Sansocizer DOP) were mixed with 100 mass parts of a polyvinyl chloride resin (Shin Daiichi PVC Co., Ltd., polyvinyl chloride resin, trade name: Zest) with a Henschel mixer followed by kneading with an 8-inch roller, molding with a hot press and using for evaluation.

### COMPARATIVE EXAMPLE 8

Polybutadiene (JSR, trade name: RB810) was kneaded with an 8-inch roller and molded with a hot press followed by using for evaluation.

[Measurement and Evaluation Methods]

The physical properties and characteristics of the raw material polyolefins, chlorinated polyolefins and chlorinated polyolefin compositions were measured and evaluated using the methods described below.

### (Heat of Crystal Fusion)

The amount of heat of crystal fusion was evaluated by measuring the heat of crystal fusion using a differential scanning calorimeter in compliance with JIS K7121 and JIS K7122.

### (Melt Flow Rate; MFR)

MFR was measured at a load of 2.16 kg and temperature of 190° C. for the raw material polyolefins or at a load of 21.6 kg and temperature of 180° C. for the chlorinated polyolefins and chlorinated polyolefin compositions in compliance with JIS K7210.

### (Mean Particle Diameter)

Mean particle diameter (or particle size) was calculated from the weight remaining for each mesh size after sizing with a Ro-Tap type sieve shaker using a sieve.

### (Hardness and Rebound Resilience)

Hardness was measured using a JIS A hardness tester in compliance with JIS K6253.

Rebound resilience was measured in compliance with JIS K6255.

### (Internal Haze)

Internal haze was measured with the Haze & Reflectometer manufactured by Murakami Color Research Laboratory (Model HR-100) by additionally pressing a pressed sheet having a thickness of 1 mm to a thickness of about 300 microns and coating both sides with liquid paraffin.

### (Specific Gravity)

Specific gravity was measured according to the water immersion method (Automatic Densimeter Model D-S manufactured by Toyo Seiki).

### (Tensile Test)

Tensile tests were used to measure 100% modulus, tensile break strength and tensile break elongation using a no. 3 dumbbell at 500 mm/min in compliance with JIS K6251.

### (Adhesive Strength)

Adhesive strength was measured by cutting a 1 mm thick pressed sheet into two strips measuring 3 cm×15 cm. Cyclohexanone was applied to the area being from the end to 4 cm from the end in the lengthwise direction of one of the strips, the second strip was placed on top and allowed to stand in the absence of a load for 24 hours at room temperature. After opening up the 11 cm portion of the strip not coated with cyclohexanone, one of the strips was attached to the upper knob of a tensile tester while the other strip was attached to the lower knob followed by measuring peel strength in the same manner as a tensile test. The maximum value read from the chart was used as the value for adhesive strength.

(γ ray-resistance)

γ ray-resistance was evaluated by carrying out a tensile test after radiating the no. 3 dumbbell used in the tensile test with 25 kGy sterilizing dose followed by measuring the 100% modulus, tensile break strength and tensile break elongation, subtracting the values of the samples before irradiation from the values of the samples after irradiation, dividing by the values of the samples before irradiation and multiplying by 100 to determine the rate of change.

[Results of Evaluation]

Examples 1 to 9 were all transparent and demonstrated internal haze values of less than 2.0, and demonstrated high adhesive strength using solvent of 3.0 or more. In addition, there were little changes in physical properties following γ-ray irradiation, and the samples were conversely soft and tough, having changed in a preferable manner as if they had undergone electron beam crosslinking. The results of the hardness, rebound resilience and tensile tests were within preferable ranges in the case of molding into a tube.

In contrast, Comparative Example 1 demonstrated high internal haze of 5 or more and inadequate transparency. Adhesive strength was also somewhat low at 2.2, and was unsatisfactory for the intended applications of the present invention. Although Comparative Example 2 demonstrated satisfactory internal haze and adhesive strength, it was excessively hard as indicated by its hardness and modulus. Since it also changed considerably following γ-ray irradiation, it was also unsuitable. Yellow discoloring was also observed.

Comparative Example 3 was an amorphous polymer, and since it had no constraining phase of a thermoplastic elastomer, in addition to the internal haze being somewhat high, it was excessively soft as indicated by its hardness and modulus, easily stretched to an irreversible degree by drawing out, or closed easily, thereby making it unsuitable as a tube material. Although Comparative Example 4 demonstrated satisfactory adhesive strength, the hardness and modulus were somewhat high, and the internal haze value was also high, indicating inferior transparency.

Similarly, Comparative Example 5 demonstrated high values for hardness and modulus, resulting in inadequate softness for use as a tube. In addition, transparency was also somewhat unsatisfactory. Comparative Example 6 was conversely excessively soft, and similar to Comparative Example 3, easily stretched to an irreversible degree by drawing out or obstructed easily, thereby making it unsuitable for a tube material.

Comparative Example 7 was composed of soft polyvinyl chloride, and although it demonstrated balanced characteristics, since DOP was added as the plasticizer, it was inferior with respect to resistance to γ-ray sterilization. Although the polybutadiene of Comparative Example 8 demonstrated satisfactory transparency, it was not adhered with solvent and demonstrated inferior resistance to γ-ray sterilization.

The results obtained from the above-mentioned examples and comparative examples are summarized in Table 1 below.

TABLE 1

| | | | | Chlorinated polyolefin | | | | | | |
|---|---|---|---|---|---|---|---|---|---|---|
| | | | | (CPO) | | | | | | |
| | | Raw material | | | | Heat of | Composition | | | |
| | | polyethylene | | Cl | | crystal | | | Hydro- | |
| | | MFR | Density | content | HLMFR | fusion | CPO | ESBO | talcite | Rikemal |
| | | g/10 min. | g/cm³ | Mass % | g/10 min. | J/g | Parts by mass | | | |
| Examples | 1 | 17 | 0.912 | 30 | 120 | 30 | 100 | 5 | 0.5 | 0.2 |
| | 2 | 7.5 | 0.956 | 35 | 50 | 39 | 100 | 10 | 0.5 | 0.2 |
| | 3 | 17 | 0.912 | 30 | 120 | 30 | 100 | 10 | 0.5 | 0.2 |
| | 4 | 15 | 0.910 | 30 | 115 | 32 | 100 | 5 | 0.5 | 0.2 |
| | 5 | 17 | 0.912 | 35 | 95 | 23 | 100 | 10 | 0.5 | 0.2 |
| | 6 | 17 | 0.912 | 30 | 142 | 21 | 100 | 5 | 0.5 | 0.2 |
| | 7 | 20 | 0.960 | 40 | 32 | 40 | 100 | 10 | 0.5 | 0.2 |
| | 8 | 2.5 | 0.921 | 30 | 19 | 33 | 30 | 5 | 0.5 | 0.2 |
| | | 17 | 0.912 | 30 | 120 | 30 | 70 | | | |
| | 9 | 11 | 0.919 | 30 | 43 | 31 | 100 | 5 | 0.5 | 0.2 |
| Comp. | 1 | 17 | 0.912 | 20 | 180 | 45 | 100 | 5 | 0.5 | 0.2 |
| Ex. | 2 | 7.5 | 0.956 | 50 | 15 | 20 | 100 | 10 | 0.5 | 0.2 |
| | 3 | 7.5 | 0.956 | 30 | 94 | 0.2 | 100 | 5 | 0.5 | 0.2 |
| | 4 | 7.5 | 0.965 | 40 | 13 | 31 | 100 | 0 | 0 | 0 |
| | 5 | 20 | 0.960 | 40 | 32 | 40 | 100 | 0.5 | 0.01 | 0.01 |
| | 6 | 8 | 0.890 | 30 | 80 | 19 | 100 | 5 | 0.5 | 0.2 |

| | | | | | | |
|---|---|---|---|---|---|---|
| 7 | — | — | — | — | — | Soft polyvinyl chloride resin |
| 8 | — | — | — | — | — | Polybutadiene |

| | | Evaluation of Characteristics | | | | | | | | |
|---|---|---|---|---|---|---|---|---|---|---|
| | | | | | | | | Tensile | | |
| | | | Rebound | Internal | | Specific | 100% | break | | Adhesive |
| | | Hardness | resilience | haze | HLMFR | gravity | modulus | strength | Elongation | strength |
| | | JIS A | % | % | g/10 min. | — | MPa | MPa | % | kg/cm |
| Examples | 1 | 69 | 25 | 0.9 | 115 | 1.10 | 2.4 | 7.5 | 910 | 3.0 |
| | 2 | 72 | 15 | 1.6 | 29 | 1.16 | 2.3 | 12.3 | 680 | 4.4 |
| | 3 | 66 | 23 | 0.9 | 130 | 1.10 | 2.5 | 6.6 | 1090 | 3.5 |
| | 4 | 68 | 25 | 1.0 | 109 | 1.10 | 2.3 | 7.7 | 930 | 3.1 |
| | 5 | 70 | 14 | 0.8 | 90 | 1.15 | 2.4 | 10.8 | 750 | 4.1 |
| | 6 | 62 | 22 | 0.9 | 137 | 1.09 | 1.8 | 4.0 | 1080 | 3.6 |
| | 7 | 79 | 10 | 1.3 | 34 | 1.21 | 2.9 | 18.1 | 530 | 3.7 |
| | 8 | 68 | 22 | 1.2 | 55 | 1.10 | 2.7 | 10.4 | 880 | 3.3 |
| | 9 | 67 | 20 | 1.0 | 45 | 1.10 | 2.7 | 11.1 | 850 | 3.2 |
| Comp. | 1 | 81 | 45 | 5.6 | 164 | 1.05 | 2.8 | 16.7 | 550 | 2.2 |
| Ex. | 2 | 82 | 5 | 1.2 | 12 | 1.29 | 3.5 | 15.2 | 430 | 4.7 |
| | 3 | 55 | 32 | 2.5 | 90 | 1.08 | 1.3 | 8.8 | 910 | 4.8 |
| | 4 | 85 | 9 | 3.2 | 13 | 1.21 | 3.1 | 17.0 | 510 | 4.4 |
| | 5 | 88 | 11 | 2.2 | 23 | 1.22 | 5.7 | 14.1 | 330 | 4.7 |
| | 6 | 60 | 28 | 0.9 | 74 | 1.09 | 0.9 | Unbroken | >1600 | 3.8 |
| | 7 | 72 | 14 | 0.8 | 80 | 1.19 | 5.2 | 14.9 | 400 | 4.8 |
| | 8 | 75 | 39 | 0.4 | 200 | 1.04 | 2.4 | 9.8 | 690 | 0.0 |

TABLE 2
Evaluation of Characteristics

| After γ-ray irradiation | | | Rate of change after γ-ray irradiation | | |
|---|---|---|---|---|---|
| | Tensile break | | | Tensile break | |
| 100% modulus | strength | Elongation | 100% modulus | strength | Elongation |
| MPa | MPa | % | % | % | % |
| 2.5 | 8.0 | 930 | 4.2 | 6.7 | 2.2 |
| 2.5 | 14.3 | 730 | 8.7 | 16.3 | 7.4 |
| 2.7 | 7.2 | 1110 | 8.0 | 9.1 | 1.8 |
| 2.3 | 8.2 | 960 | 0.0 | 6.5 | 3.2 |
| 2.5 | 11.1 | 810 | 4.2 | 2.8 | 8.0 |
| 1.9 | 5.2 | 1100 | 5.6 | 30.0 | 1.9 |
| 3.2 | 23.0 | 620 | 10.3 | 27.1 | 17.0 |
| 2.8 | 11.2 | 900 | 3.6 | 7.1 | 2.2 |
| 2.8 | 12.7 | 910 | 3.6 | 12.6 | 6.6 |
| 2.9 | 18.5 | 610 | 3.6 | 10.8 | 10.9 |
| 3.7 | 17.1 | 440 | 5.7 | 12.5 | 2.3 |
| 1.6 | 9.4 | 960 | 23.1 | 6.8 | 5.5 |
| 3.3 | 18.8 | 550 | 6.5 | 10.6 | 7.8 |
| 5.7 | 16.0 | 340 | 0.0 | 13.5 | 3.0 |
| 1.3 | Unbroken | >1600 | 44.4 | — | — |
| 6.0 | 7.3 | 330 | 15.4 | −51.0 | −17.5 |
| 4.0 | 5.5 | 130 | 66.7 | −43.9 | −81.2 |

HLMFR: Melt flow rate at a load of 21.6 kg
ESBO: Epoxidized soybean oil

### INDUSTRIAL APPLICABILITY

According to the present invention, a chlorinated polyolefin and composition thereof can be provided that has superior safety due to substantial absence of a plasticizer such as DOP or TOTM, allows γ-ray sterilization and has a solvent adhesion property, and shows superior transparency, mechanical strength, permanent elongation and anti-crazing. In addition, the present invention is useful as a medical device or packaging material for medical and food applications due to its superior performance, high degree of safety and environmental considerations as a result of using as a tube, sheet or film.

1. A chlorinated polyolefin composition, comprising 100 mass parts of a chlorinated polyolefin, 1 to 15 mass parts of an epoxy derivative, and 0.05 to 3 mass parts of a stabilizer;
wherein the chlorinated polyolefin is obtained by chlorinating a polyolefin being selected from ethylene homopolymer or ethylene-α-olefin copolymer, and has a density of 0.90 or more; and the chlorinated polyolefin has a chlorine content of 25 to 45% by mass, a melt flow rate of 0.1 to 300 g/10 minutes, and a heat of crystal fusion as determined by DSC of 20 to 60 J/g;
the epoxy derivative is selected from epoxidized unsaturated oil, and epoxidized unsaturated fatty acid ester, epichlorhydrin derivative and epoxycyclohexane derivative, and
the stabilizer is selected from a hydrotalcite minerals.

2. A chlorinated polyolefin composition according to claim 1, which further comprises 0.05 to 3 mass parts of a lubricant selected from fatty acid derivatives.

3. A chlorinated polyolefin composition according to claim 1, which has a rebound resilience of 60% or less and a JIS-A hardness of 50 to 90.

4. A chlorinated polyolefin composition according to claim 1, which has an internal haze of 3% or less.

5. A chlorinated polyolefin composition according to claim 1, wherein the epoxy derivative is an epoxidized soybean oil.

6. A chlorinated polyolefin composition according to claim 1, wherein the stabilizer selected from hydrotalcite minerals is hydrotalcite.

7. An article comprising a composition according to claim 1 or a crosslinked product thereof, which has a form or shape of tube, sheet, film or cast molded product capable of constituting a medical device, health care supply or pharmaceutical packaging.

8. An article comprising a composition according to claim 1 or a crosslinked product thereof, which has a form or shape of tube, sheet or film capable of constituting a food container or packaging material; hose or sheet for industrial use; or molded product for food packaging or industrial use.

9. An article according to claim 7, which has been sterilized by γ-ray radiation
